(19) United States
(12) Patent Application Publication
(10) Pub. No.: US 2006/0254104 A1
(43) Pub. Date: Nov. 16, 2006

(54) Method for reminding a driver of minimum vehicle clearance requirements and clearance requirements reminder apparatus

(76) Inventors: Robert Frederick Hipple JR., Indianapolis, IN (US); Thomas Edward BonDurant, Indianapolis, IN (US)

Correspondence Address: ICE MILLER LLP, ONE AMERICAN SQUARE, SUITE 3100, INDIANAPOLIS, IN, 46282-0200, US

(21) Appl. No.: 11/402,763

(22) Filed: Apr. 12, 2006

Related U.S. Application Data
(63) Continuation-in-part of application No. 10/838,028, filed on May 3, 2004, now abandoned.

(51) Int. Cl. G09F 7/22

(52) U.S. Cl. 40/617

(57) ABSTRACT

A reminder system to remind a driver to check the height of a vehicle for adequate clearance in an area with a height restricted opening. One embodiment of the reminder system includes a warning sign attachable to a garage door, a windshield sticker and a visor sign to remind the driver of the height of the vehicle.

### CLAIM OF PRIORITY

This application is a continuation in-part application of and claims the benefit of co-pending U.S. patent application Ser. No. 10/838,028.

### STATEMENT CONCERNING FEDERALLY SPONSORED RESEARCH

There has been no federally sponsored research or development of the invention.

### FIELD OF THE INVENTION

The present invention relates to a reminder system for a driver of a vehicle, and more particularly to a reminder system to remind the driver of a vehicle to check whether the vehicle height will exceed the maximum height which can safely navigate into an area.

### BACKGROUND OF THE INVENTION

Many drivers are not familiar with the precise height of the vehicle which they are driving, whether the vehicle is one they own or is a rented or borrowed vehicle. Overhead clearances of various openings in public and private areas, such as covered drive-through service areas of different businesses and parking garages, are sometimes marked with maximum height of vehicles which can safely enter the public area. Other times, such areas are not marked.

Most people drive with a loaded vehicle on an infrequent basis. Therefore, they are accustomed to the standard height of their automobile. Placing outdoor recreation equipment (bicycles, kayaks, snow boards, and the like), luggage or other items on top of a vehicle changes the minimum clearance requirement in a garage. The change in clearance requirement is easy to forget regardless of the experience of the driver. If the driver forgets about the change in clearance requirement, the bicycle or other cargo could strike the garage door or garage opening, causing severe damage to the equipment, roof rack, vehicle and the garage.

### SUMMARY OF THE INVENTION

In one embodiment of the invention, a system for reminding the driver of a vehicle to check for adequate clearance prior to entering a height-restricted area includes a cord having a length and a first end and an opposite second end, a warning sign formed to include means for receiving the cord adjacent the first end of the cord, an attachment means for attaching the cord adjacent the second end of the cord to an inside of the garage door. The cord is attached adjacent its first end to the warning sign at the receiving means, and adjacent its second end attached to the attachment means. The attachment means is attached to the inside of the garage door adjacent a central portion of the garage door so that when the garage door is in a closed position, a bottom portion of the warning sign is suspended relatively higher than a bottom of the garage door. When the garage door is in an open position permitting entry into the garage, the warning sign hangs in the vehicle entryway.

In another embodiment of the invention, a method for reminding a driver of a vehicle of the vehicle's minimum vehicle clearance requirements includes the step of providing a reminder system in the form of a kit including at least one of the following: a warning sign having attachment means for attaching the warning sign to an object, a windshield sticker for attachment in the driver's cabin of the vehicle, and a visor sign configured to be attached to the visor of the vehicle. The method further includes the step of printing indicia on the at least one of warning sign, windshield sticker, and visor sign prompting a user to write a maximum height associated with the vehicle thereon.

In another embodiment of the invention, a kit for warning a driver of maximum vehicle height clearance in an area includes a warning sign configured to be attached to an object to warn a driver of the maximum vehicle height clearance, at least one windshield sticker configured to be attached to the driver's cabin of the vehicle, and packaging to retain the warning sign and at least one windshield sticker together.

Additional features and advantages of the invention will become apparent to those skilled in the art upon consideration of the following detailed description of preferred embodiments exemplifying the best mode of carrying out the invention as presently perceived.

### BRIEF DESCRIPTION OF THE DRAWINGS

FIG. 1 shows a reminder system including a warning sign, cord, attachment device, windshield sticker, and visor sign;

FIG. 2 is packaging for the reminder system showing the front and rear view of the packaging;

FIG. 3 is a view of the interior of a garage showing the interior-facing side of a garage door with the attachment device attached to a central portion of the garage door and the warning sign coupled to the attachment device with the cord;

FIG. 4 is a view of the exterior of a garage showing the garage door in the open position and the warning sign hanging in an entryway of the garage in the path of a vehicle entering the garage, and hanging in the front half of the garage;

FIG. 5 is a close up perspective view of the attachment device;

FIG. 6 is a view of the interior of a vehicle from the driver's seat showing a visor in the lowered position and the visor sign clipped to the visor;

FIG. 7 is a view similar to FIG. 6 without the visor, showing a windshield sticker positioned in the upper left corner of the windshield; and

FIG. 8 shows the warning sign with a cord receiver formed therein and alternative views of the cord, one showing the cord tied with an overhand knot and the other with the cord formed into a loop crimped with a crimp.

### DETAILED DESCRIPTION

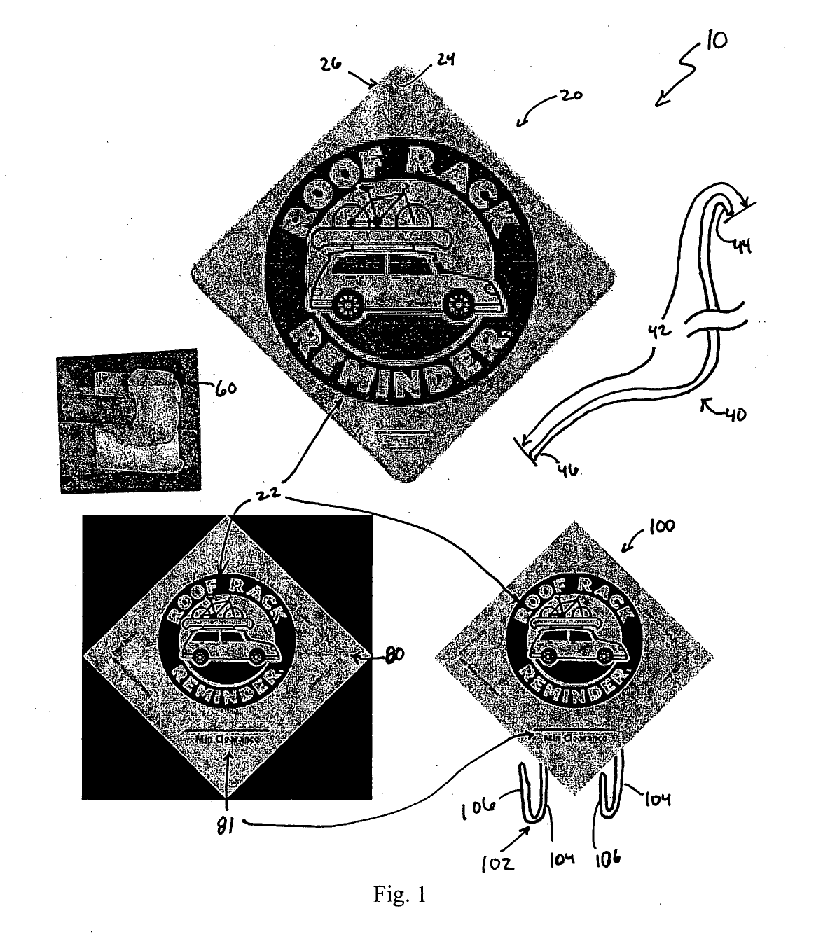

FIG. 1 illustrates a reminder system 10 including a warning sign 20, a cord 40, attachment device 60, windshield sticker 80, and visor sign 100. Warning sign 20, windshield sticker 80, and visor sign 100 are all illustratively diamond shaped with first indicia 22 thereon showing an image of a vehicle with cargo stored on a roof rack thereof. Windshield sticker 80 and visor sign 100 illustratively include second indicia 81 prompting a user to write the maximum height of the vehicle, and if applicable, any cargo stored on top of the vehicle, into such second indicia.

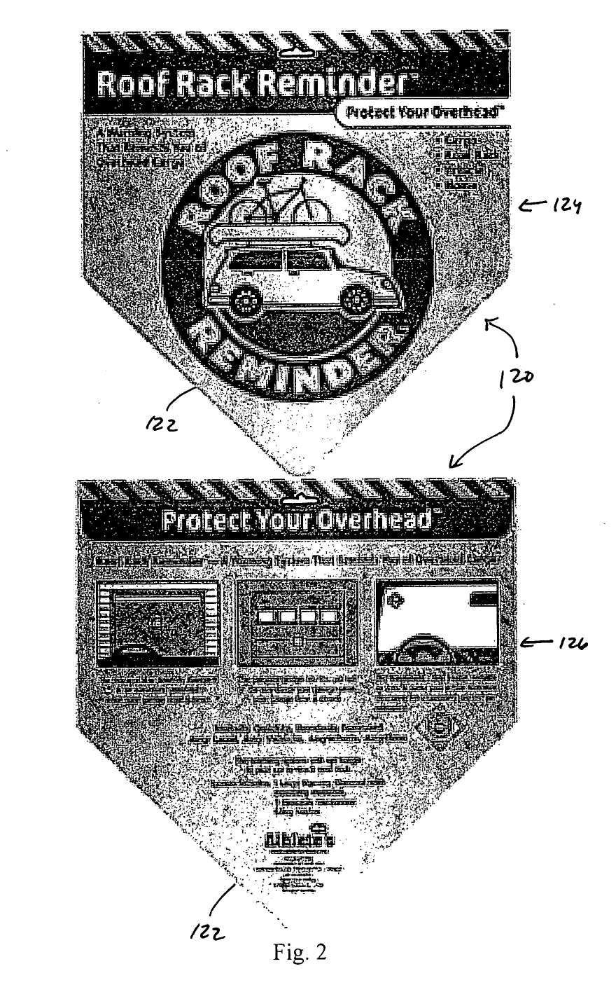

FIG. 2 illustrates exemplary packaging 120 in which some or all parts of reminder system 10 may be packaged and sold in kit form, and is discussed in greater detail below.

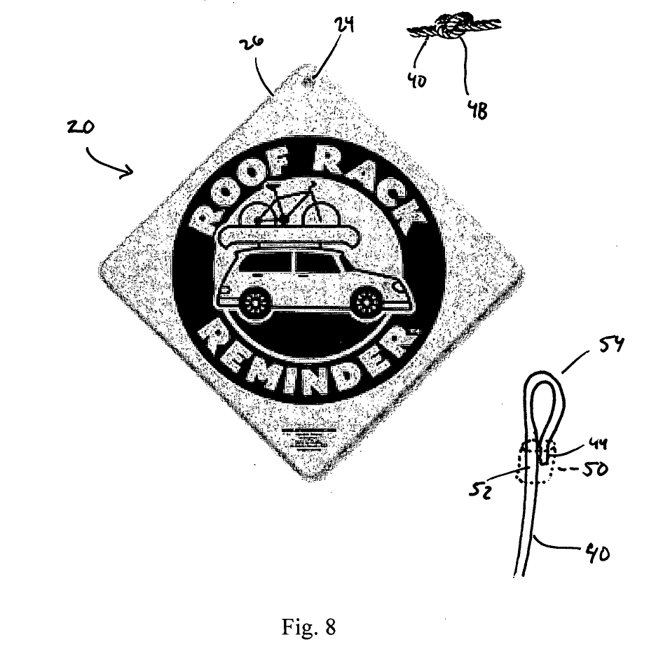

Referring to FIGS. 1 and 8, warning sign 20 includes a cord receiver 24 adjacent a top corner 26 thereof. Cord receiver 24 is illustratively a hole, however cord receiver 24 could be a variety of different receiving means, for example a differently-shaped opening, a spring-loaded clip or device such as attachment device 60 attached to warning sign 20, a protrusion attached to warning sign 20 to enable a user to tie cord 40 to the protrusion, or warning sign 20 could be shaped so that cord receiver 24 is integral with warning sign 20 and cord 40 can be tied to the cord receiver 24.

Referring to FIG. 1, cord 40 has a length 42, illustratively forty-eight (48) inches. Cord 40 includes a first end 44 and an opposite second end 46. As depicted illustratively in FIG. 8, cord 40 and cord receiver 24 are sized, one relative to the other, so that when an overhand knot 48 (for example) is tied in cord 40, knot 48 is generally larger than the hole that is cord receiver 24. Illustratively, cord receiver 24 is a hole with a diameter of approximately ¼ inch, and cord 40 is approximately ⅛ inch in diameter. Knot 48 is tied adjacent first end 44 and second end 46 is passed through cord receiver 24. Knot 48 then engages the portion of warning sign 20 adjacent cord receiver 24 to prevent warning sign 20 from falling off cord 40 when reminder system 10 is installed.

As illustrated in FIG. 8, alternatively, a cord clip or crimp 50 (shown in phantom) is crimped around first end 44 and another segment 52 of cord 40 to form a loop 54 in cord 40. Second end 46 is passed through cord receiver 24 and then loop 54 to attach cord 40 to warning sign 20. Loop 54 then engages the portion of warning sign 20 adjacent cord receiver 24 to prevent warning sign 20 from falling off cord 40 when reminder system 10 is installed.

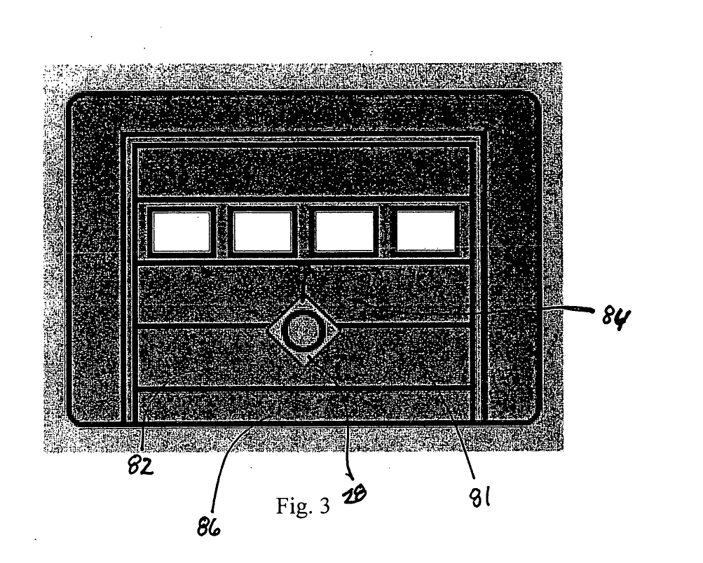

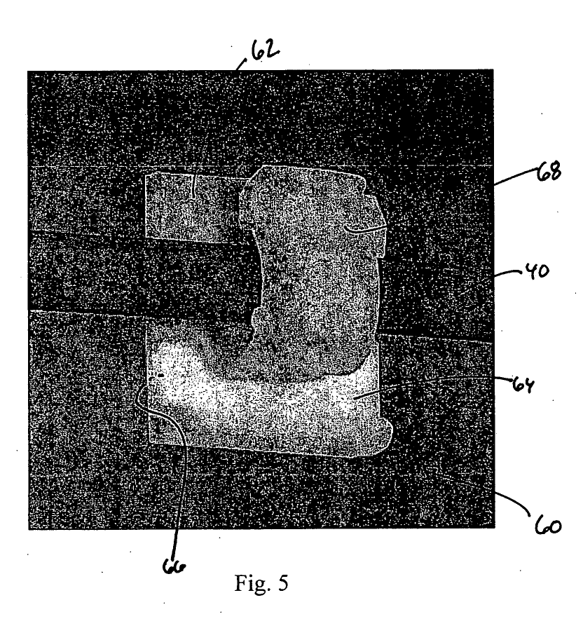

As illustrated in FIG. 3, second end 46 of cord 40 is attached to attachment device 60 to retain cord 40 in fixed position relative to attachment device 60. Referring specifically to FIG. 5, attachment device 60 includes a body 62 having a front 64 and a back 66. An adhesive (not shown) is applied to back 66 and is illustratively covered with a protective tape during transit. A user removes the protective tape to expose the adhesive prior to applying attachment device 60 to an object. As illustrated in FIG. 5, attachment device 60 further includes a clip 68 which is illustratively somewhat c-shaped and formed integrally with body 62. Clip 68 extends from the front 64 of body 62 and is spaced apart from the surface of front 64 an amount relative to the diameter of cord 40 capable of receiving, but still securing, cord 40 between clip 68 and front 64. For additional security, another knot such as knot 48 or loop such as loop 54 formed using crimp 50 as described above, may be formed in second end 46 of cord 40 to prevent cord 40 from becoming dislodged from attachment device 60.

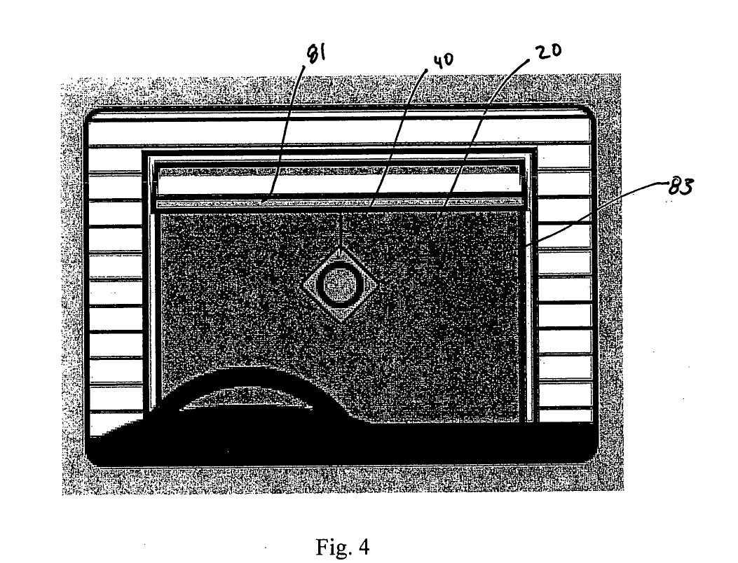

Attachment device 60 is secured to an object to support warning sign 20 in a position to warn a driver to check for adequate clearance. As illustrated in FIG. 3, attachment device 60 is attached to a garage door 81. Garage door 81 is illustrated in FIG. 3, and includes an interior 82 which faces the interior of the garage when garage door 81 is in the lowered or closed position of FIG. 3. Attachment device 60 is attached to interior 82 of garage door 81 adjacent a central portion 84 thereof so that when garage door 81 is in the lowered position, a bottom portion 28 of warning sign 20 is suspended relatively higher than a bottom 86 of garage door 81 to avoid interference with automatic sensors (not shown) with which garage doors are commonly equipped. When garage door 81 is in an open position depicted in FIG. 4, permitting entry into the garage, warning sign 20 hangs in the vehicle entryway 12.

By securing attachment device 60 adjacent central portion 84 of garage door 81, when garage door is in the open position, warning sign 20 hangs visibly in entryway 83 of the garage so that the user and driver of the vehicle would have to contact warning sign 20 to park fully in the garage, thereby discouraging the user/driver from entering the garage in the first place. Said another way, warning sign 20 is in the path of a vehicle so that to pull the vehicle fully in the garage the user would have to contact the warning sign with the vehicle before the vehicle is fully parked in the garage. Said yet another way, warning sign 20, when garage door 81 is in the open position, hangs in the front half of the garage.

Alternatively, attachment device 60 (or warning sign 20 itself through use of any suitable adhesive, fastener, or other coupling mechanism) may be secured to any other object in an effort to inform the driver of a vehicle of a maximum height threshold of the public or private area in which the driver may navigate. For example, and not by way of limitation, attachment device 60 (or warning sign 20) may be secured to a low-hanging wire, the entry structure of an opening in a building such as a parking garage, or the frame or other structure of an awning or overhang. In such applications, the indicia 22 on warning sign 20 may include indicia prompting the user to enter the maximum height of a vehicle that can navigate the concerned area.

In the illustrative version shown in FIG. 5, attachment device 60 may be obtained from Panduit Corp. located at 17301 Ridgeland Avenue Tinley Park, Ill. 60477, Tel: 800-777-3300, Fax: 708-532-1811, or online at www.panduit.com.

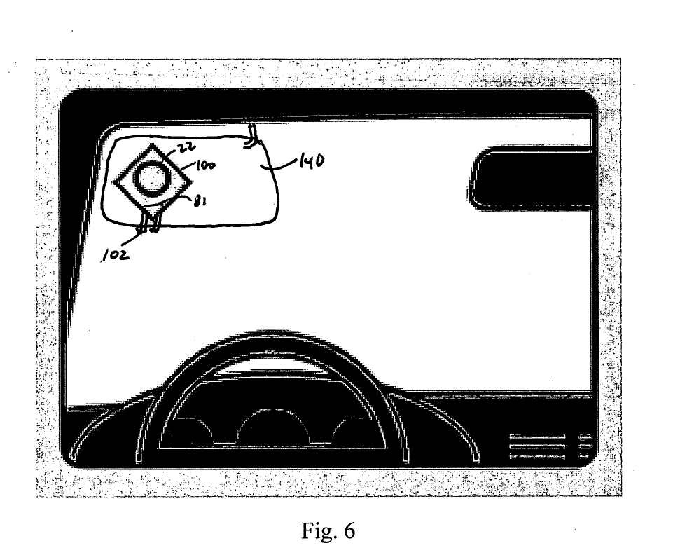

Referring now to FIG. 6, the interior of a vehicle is depicted with a visor 140 in the lowered position. Visor sign 100 includes a clip 102 coupled thereto. Clip 102 is illustratively a metal clip that through spring tension pinches visor 140 between arms 104 of clip 102 and returns 106 of clip 102. Alternatively, clip 102 may include one or more arms coupled to visor sign 100 so that visor 140 is pinched between the arm(s) and visor sign 100. Clip 102 may be any suitable material such as plastic, an alloy, or other material that will pinch visor 140 between clip 102 and visor sign 100 and secure visor sign 100 in position relative to visor 140. In an alternative embodiment (not shown), in place of or in addition to clip 102, an adhesive or other fastener may be used, for example a glue or similar adhesive, hook and/or look fasteners, an elastic band or strap, Visor sign 100 is shown attached to visor 140 so that, when the visor is in the lowered position, the driver can see visor sign 100. Visor sign 100 is clipped to visor with clip 102.

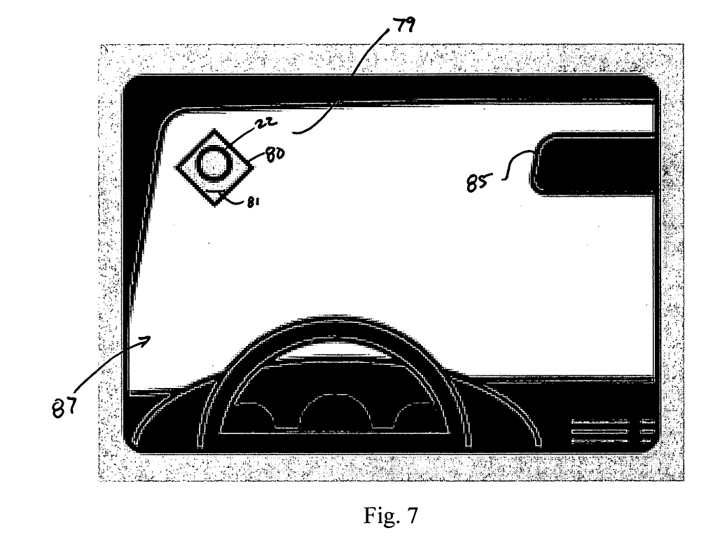

Referring now to FIG. 7, the interior of a vehicle is depicted with a driver's cabin 87 having windshield 79 and rearview mirror 85. Windshield sticker 80 is shown attached to windshield 79 so that sticker 80 is in the upper left position. Windshield sticker 80 may be positioned in any location on windshield 79 or in other locations within the driver's cabin such as on rearview mirror 85, however for safety certain positions are more suitable than others. Windshield stickers 80 are a plastic material that through static cling adheres to windshield 79. In an alternative embodiment (not shown), in place of or in addition to the static clingability of windshield stickers 80, an adhesive or other fastener may be used, for example a glue or similar adhesive, hook and/or look fasteners (one of which would be attached to the windshield), a suction cup, or other suitable fastening means. Windshield stickers 80 may be obtained from TLF Graphics at 172 Metro Park, Rochester, N.Y. 14623-2699, TEL (585) 272-5500, FAX (585) 272-5525, or online at www.tlfgraphics.com.

Referring again to FIG. 2, packaging 120 is sized to approximate at a lower region 122 thereof the shape of the bottom half of warning sign 20. In practice, packaging 120 is either a single piece which is folded as shown in FIG. 2 or may be two separate pieces (front and back) which are sandwiched together around the contents of the reminder system 10 kit, and secured using plastic wrap, shrink wrap, adhesive, fasteners, or other suitable materials. Packaging 120 in the embodiment of FIG. 2 is folded so that the front 124 of package 120 shown at the top of FIG. 2 corresponds in shape to the back 126 of package 120 shown at the bottom of FIG. 2. The contents of the kit are enclosed between the folded front and back, and may include any combination of the following: one or more warning signs 20, one or more cords 40, one or more attachment devices 60, one or more windshield stickers 80, and one or more visor signs 100.

Different sizes of kits are suitable for different applications. For example, it may be useful for users using the kit for personal use to include a single warning sign 20, one cord 40, and one attachment device 60 are sufficient to enable such personal user to hang warning sign 20 from his or her garage door 14; however, it may be useful for the personal user to have one or a plurality of either or each of windshield stickers 80 and visor signs 100. Further, it may be useful to include in a kit designed for commercial use a plurality of warning signs 20 and a corresponding number of cords 40 and attachment devices 60, with a larger supply of windshield stickers 80 and/or visor signs 100.

A method for reminding a driver of a vehicle of the minimum vehicle clearance requirements includes the step of providing a windshield sticker 80 having indicia printed thereon prompting a user to enter the minimum vehicle clearance requirements. The method further includes the step of writing the minimum vehicle clearance requirements on the windshield sticker. The method further includes positioning the windshield sticker in the driver's cabin such as on windshield 79 or rearview mirror 85 to serve as a reminder to the driver of the vehicle's minimum clearance requirements.

A method for reminding a driver of a vehicle of the minimum vehicle clearance requirements includes the step of providing a reminder system 10 in the form of a kit including one or more of the following: warning sign 20, cord 40, attachment device 60, a windshield sticker 80, and visor sign 100. The method may include attaching the warning sign to an object to support warning sign 20 in a position to warn a driver to check for adequate clearance. The method may include attaching warning sign 20 to the central portion 84 of garage door 81. The method may include attaching warning sign 20 to cord 40 adjacent a first end 44 thereof and to attachment device 60 at a second end 46 thereof. The method may include attaching attachment device 60 to central portion 84 of garage door 81. The method may include clipping visor sign 100 to visor 120 of the vehicle so that when the visor is in the lowered position visor sign 120 is visible to the driver. The method may include adhering windshield sticker 80 to windshield 79 so that windshield sticker 80 is visible to the driver.

Although the invention has been described in detail with reference to certain preferred or illustrative embodiments, variations and modifications exist within the scope and spirit of the invention as described and as defined in the claims.

What is claimed is:

1. A system for reminding the driver of a vehicle to check for adequate clearance prior to entering a height-restricted area, the system comprising:
a cord having a length and a first end and an opposite second end,
a warning sign formed to include means for receiving the cord adjacent the first end of the cord,
an attachment means for attaching the cord adjacent the second end of the cord to an inside of the garage door,
the cord attached adjacent its first end to the warning sign at the receiving means, and adjacent its second end attached to the attachment means,
the attachment means attached to the inside of the garage door adjacent a central portion of the garage door so that when the garage door is in a closed position, a bottom portion of the warning sign is suspended relatively higher than a bottom of the garage door, and,
when the garage door is in an open position permitting entry into the garage, the warning sign hangs in the vehicle entryway.

2. The system of claim 1, further comprising a windshield sticker configured to be attached to a windshield.

3. The system of claim 2, wherein the windshield sticker has indicia printed thereon to prompt a driver to write a maximum height associated with the vehicle thereon.

4. The system of claim 2, wherein the windshield sticker is generally diamond-shaped.

5. The system of claim 1 further comprising a visor sign configured to be attached to a visor.

6. The system of claim 5, wherein the visor sign is generally diamond-shaped.

7. A method for reminding a driver of a vehicle of the vehicle's minimum vehicle clearance requirements, comprising the steps of:
providing a reminder system in the form of a kit including at least one of the following: a warning sign having attachment means for attaching the warning sign to an object,
a windshield sticker for attachment in the driver's cabin of the vehicle, and
a visor sign configured to be attached to the visor of the vehicle;
printing indicia on the at least one of warning sign, windshield sticker, and visor sign prompting a user to write a maximum height associated with the vehicle thereon.

8. The method of claim 7, wherein the step of printing indicia prompting a user to write a maximum height associated with the vehicle further includes printing indicia prompting the user to write a maximum height associated with the vehicle when the vehicle is carrying cargo thereon.

9. The method of claim 7, wherein the step of printing indicia prompting a user to write a maximum height associated with the vehicle further includes printing indicia prompting the user to write a maximum height associated with the vehicle only without any cargo thereon.

10. The method of claim 7, wherein the step of providing a reminder system includes providing a reminder system in the form of a kit including a plurality of warning signs having attachment means for attaching the warning sign to an object.

11. The method of claim 10, wherein the step of providing a reminder system further includes providing a reminder system wherein the means for attaching the warning sign to an object is a cord and an attachment device, wherein the warning sign includes a cord receiver, and wherein the attachment device is configured to be attached to an object and to attachably receive the cord at a second end of the cord.

12. The method of claim 7, wherein the step of providing a reminder system includes providing a reminder system in the form of a kit including a plurality of windshield stickers for attachment in the driver's cabin of the vehicle.

13. The method of claim 12, wherein the step of providing a reminder system includes providing a reminder system wherein the windshield stickers are configured for attachment to a windshield of the vehicle by static cling.

14. The method of claim 7, wherein the step of providing a reminder system includes providing a reminder system in the form of a kit including a plurality of visor signs configured to be attached to the visor of the vehicle.

15. The method of claim 7, wherein the step of providing a reminder system includes providing a reminder system in the form of a kit including at least one each of a warning sign having attachment means for attaching the warning sign to an object, a windshield sticker for attachment in the driver's cabin of the vehicle, and a visor sign configured to be attached to the visor of the vehicle.

16. A kit for warning a driver of maximum vehicle height clearance in an area comprising:
a warning sign configured to be attached to an object to warn a driver of the maximum vehicle height clearance,
at least one windshield sticker configured to be attached to the driver's cabin of the vehicle, and
packaging to retain the warning sign and at least one windshield sticker together.

17. The kit of claim 16 further comprising at least one visor sign configured to be attached to a visor in the vehicle.

18. The kit of claim 16, wherein the warning sign and the windshield sticker are of a substantially similar geometric shape.

19. The kit of claim 16, wherein the shape of at least a portion of the packaging and at least a portion of the warning sign are substantially identical.

20. The kit of claim 16 further comprising an attachment device and a cord, wherein the attachment device is configured for attachment to an object, and the cord is configured to attach the warning sign to the attachment device.
